(19) United States
(12) Patent Application Publication
(10) Pub. No.: US 2019/0391651 A1
(43) Pub. Date: Dec. 26, 2019

(54) FLEXIBLE AND TACTILE PRESSURE SENSITIVE SWITCH SENSORS

(71) Applicants: Sartaj Chowdhury, Plano, TX (US); Katherine Rodríguez Hernández, Pflugerville, TX (US); Hugo Umaña Vindas, Pflugerville, TX (US); Mateusz Mittek, Lincoln, NE (US); Abrar Chowdhury, The Colony, TX (US); Charles Lee, Omaha, NE (US)

(72) Inventors: Sartaj Chowdhury, Plano, TX (US); Katherine Rodríguez Hernández, Pflugerville, TX (US); Hugo Umaña Vindas, Pflugerville, TX (US); Mateusz Mittek, Lincoln, NE (US); Abrar Chowdhury, The Colony, TX (US); Charles Lee, Omaha, NE (US)

(73) Assignee: Mayu, Inc., Chicago, IL (US)

(21) Appl. No.: 16/447,878

(22) Filed: Jun. 20, 2019

Related U.S. Application Data
(60) Provisional application No. 62/687,726, filed on Jun. 20, 2018.

(51) Int. Cl. G06F 3/01; G01L 1/18

(52) U.S. Cl. CPC G06F 3/016; G10H 1/0008; G06F 3/011; G01L 1/18

(57) ABSTRACT

Described herein is a flexible piezoresistive switch sensor responding only to a minimum threshold compression deformation force. The switch sensor comprises a non-porous housing that separates an external environment from an internal environment; one or more decoupled electrodes comprising or formed of a flexible conductor; a non conductive insulating spacer layer enforcing the one or more decoupled electrodes in bending or twisting forces, while allowing electrode coupling due to compression; a piezoresistive layer decoupled from the electrodes via the insulating spacer layer; and an elastomeric polymer layer comprising one or more buckling or spring elements configured to separate a minimum required compression force on the piezoresistive layer and the non-conductive insulating layer.

### CROSS-REFERENCE TO RELATED APPLICATIONS

This application claims the priority benefit of U.S. Provisional Patent Application Ser. No. 62/687,726, filed Jun. 20, 2018, the contents of which are herein incorporated by reference in their entirety.

### TECHNICAL FIELD

Described herein is a user interface device which utilizes pressure sensor assemblies that are flexible and respond to tactile inputs during compressive deformation without false positives being caused by bending or twisting deformations. The pressure sensor assemblies are placed in an ergonomic layout designed to parallel the positions of human hands in resting position to maximize concussive input.

### BACKGROUND

Currently, piezoresistive sensors are used throughout digital interfaces, from digital musical instruments to user interface controllers for video gaming purposes. For example, in rigid environments, digital MIDI controller makers tend to employ piezoresistive sensors in their pressure sensitive offerings. Also, in soft goods markets, wearable smart gloves used in VR may employ the use of piezoresistive sensing for both compressive and bend deformations, allowing the use of fingers for complex interactions. The natural behavior of piezoresistive sensors may create situations where false positives are created due to deformation forces not being able to measure the impact due to the resistance of the piezoresistive material. In these instances, compressive forces may impact a bend sensor, and a soft material's twists and bends may impact a compressive pressure sensor. When used in soft environments, the false positives around types of forces create an unreliable experience for the user, thus relying on software methods for removing false positives.

As such, these sensors tend to require rigid environments for reliable compression pressure sensing. These rigid designs potentially limit a user's ability to interact with the sensor, because the sensor may need to be on a hard flat surface. In live performance scenarios, such tethering to rigid surfaces limits the user's ability to move around, a use case valued by many live performers. They also prevent more physical interaction with a performer, as the rigid surface itself, like a table, may create a physical barrier between the performer and the audience.

To alleviate the issues around false positives, many digital MIDI controllers and piezoresistive based interfaces calibrate readings to require a force greater than that of normal finger press, often requiring the use of the entire hand's force. Such force limits a user's ability to trigger quick successive events. As a comparison, drum rolls found in multiple genres of popular western music can trigger around 30 hits per second. If a digital music instrumentalist wanted to mimic a drum roll using an industry standard piezoresistive instrument, the user would be able to trigger only 1 sound per hand, limiting the speed of triggering to the speed of the wrist, leaving scenarios where digital musicians may only be able to trigger around 10 hits per second, ⅓ the speed of a drum roll.

In addition to the calibration of the sensor being unusable with single finger force, the positioning of the sensors limits the user's ability to use multiple fingers simultaneously, as many instruments tend to follow more geometric designs, like matrices or linear grids. Such sensor placements make it difficult for multiple fingers to trigger sounds simultaneously and in quick succession, and also don't employ the use of the human palm, a common impact point found with many hand drumming instruments.

The common use of matrix layouts also provides little communication to audiences during performances. Given the generic nature of a matrix, a performer may configure the matrix to their own desires. However, given the custom configuration, the visual language with audience is lost, as many audience members may struggle associating individual sounds with finger triggers. Whether it is a guitar, a horn, a piano, or many classical acoustic instruments, standardization around instrument scaling made it easy for audience members to see a performer and generally be able to follow the performers instrumental performance, regardless of familiarity with the artist.

From a collaboration perspective, such standardizations in interface can promote more collaboration, as many performers are able to share instruments and perform on multiple different versions of the same instrument. However, with matrix controllers, each artist makes their own configuration, making live collaboration and knowledge transfer much more difficult.

In the context of digital performance instruments, most of these piezoresistive sensors are layered with an elastomeric polymer, such as silicone. The elastomeric polymer provides a tactile environment for fingers to press. However, the feedback from the elastomeric polymer tends to be minimal, giving the user little physical feedback on whether a sound has been triggered. When trying to tune for speed, the lack of clear tactile feedback makes it more difficult for the user to verify whether a sound is correct. For example, with computer keyboards, mechanical keyboard popularity increases among those who require speed as part of the profession, such as journalism and software engineering. This is because mechanical keyboard switch sensors provide clear tactile and audible feedback, and many have a spring like switch that assists in a quick reset of the finger. With piezoresistive digital instruments, such quick and clear feedback is nonexistent, as piezoresistive sensors don't have a switch component, and the elastomeric polymer doesn't provide a clear tactile feedback for the moment of trigger.

Given all these limitations, there is a need for a digital interface systems and methods that allows for rapid simultaneous triggers with pressure sensitivity and tactile feedback, whether it is on a rigid surface or soft surface. This invention provides such new and useful systems and methods.

### SUMMARY

One aspect of the present disclosure is directed to a flexible piezoresistive switch sensor. In some embodiments, the flexible piezoresistive switch sensor comprises a non-conductive substrate; a first plurality of electrodes formed on the non-conductive substrate; a second plurality of electrodes formed on the non-conductive or a second non-conductive substrate, with the second plurality of electrodes not in contact with the first plurality of electrodes; an insulating spacer layer, wherein the non-conductive substrate is configured to prevent contact between the first plurality of electrodes and the second plurality of electrodes unless pressure is applied; a piezoresistive substrate separated from the first and second plurality of electrodes by the insulating spacer layer; and one or more interconnected apertures defined by the insulating spacer layer which is configured to prevent contact between the first or second plurality of electrodes and the piezoresistive substrate during one or more of bend deformations and twist deformations, while allowing contact between the first plurality of electrodes and the second plurality of electrodes during compression deformation.

In some embodiments, the first plurality of electrodes and the second plurality of electrodes are both on the non-conductive substrate. In some such embodiments, the first plurality of electrodes is substantially parallel in a first direction, and the second plurality of electrodes is substantially perpendicular to the first plurality of electrodes.

In some embodiments, the first plurality of electrodes is formed on the non-conductive substrate and the second plurality of electrodes is formed on a second non-conductive substrate. In some such embodiments, the first plurality of electrodes is substantially parallel to the second plurality electrodes, such the first plurality is not in contact with the second plurality.

In some embodiments, each of the pluralities of interconnected apertures is comprised of circle, circle-like, or polygonal shapes with 3, 4, 5, 6, 7, 8, or 9 sides.

In some embodiments, a width of each aperture is equal to or less than the maximum desired bend radius at the location of the sensor.

In some embodiments, the insulating spacer layer comprises an elastomer. In some embodiments, one or more of the first plurality of electrodes and the second plurality of electrodes are printed on an elastomer.

In some embodiments, one or more of the first plurality of electrodes, or the second plurality of electrodes, or the piezoresistive element is printed on a soft goods textile material selected from the group consisting of: animal material, plant material, mineral material, and synthetic material.

Another aspect of the present disclosure is directed to an elastomeric tactile sensor pad. In some embodiments, the elastomeric tactile pad comprises a non-conductive substrate; a first plurality of electrodes formed on the non-conductive substrate; a second plurality of electrodes formed on the non-conductive substrate or a second non-conductive substrate, with the second plurality of electrodes is not in contact with the first plurality of electrodes; an insulating spacer layer, wherein the non-conductive substrate is configured to prevent contact between the first plurality of electrodes and the second plurality of electrodes unless pressure is applied; a piezoresistive substrate separated from the first and the second plurality of electrodes by the insulating spacer layer; one or more interconnected apertures defined by the insulating spacer layer which is configured to prevent contact between the plurality of electrodes and the piezoresistive substrate during one or more of bend deformations and twist deformations, while allowing contact between the first plurality of electrodes and the second plurality of electrodes during compression deformation; a plurality of interconnected buckling columns or springs comprising an elastomeric material; and a buckling point or spring resistance requiring less than 1 N of compression pressure.

In some embodiments, the plurality of interconnected buckling columns or springs comprises or is formed of geometric shapes comprising 3, 4, 5, 6, 7, 8, or 9 sided shapes.

In some embodiments, the plurality of interconnected buckling columns or springs comprises elastomeric hairs.

In some embodiments, a bottom surface of the sensor pad defines a second set of interconnected apertures configured to allow compression force applied to the sensor pad to travel through the second set of interconnected apertures. In some embodiments, the mean height is 0.1 cm to 3.5 cm.

In some embodiments, the piezoresistive element is suspended in the pad, between the interconnected buckling columns or in an axial center of the spring. In some embodiments, the piezoresistive element is suspended in the pad, between the interconnected buckling columns or in an axial center of the spring. In some embodiments, a suspended enclosure housing the piezoresistive element has a height greater than a height of the interconnected columns or the spring in a compressed configuration. In some embodiments, a mean height of the interconnected columns or the spring in a compressed configuration is 0.1 cm to 5 cm, 0.05 to 5 cm, 0.01 to 10 cm, 0.01 to 2.5 cm, etc.

### BRIEF DESCRIPTION OF THE DRAWINGS

FIG. 1 shows the compositional layers of one embodiment of the flexible switch sensor.

FIG. 2A shows one embodiment the flexible switch sensor from the bottom.

FIG. 2B shows one embodiment the flexible switch sensor from the side.

FIG. 2C shows one embodiment the flexible switch sensor from the above.

FIG. 2D shows one embodiment the flexible switch sensor from the top side.

FIG. 3 shows the compositional layers of a different embodiment the flexible switch sensor.

FIG. 4A shows one embodiment the tactile buckling layer from the top.

FIG. 4B shows one embodiment the tactile buckling layer from the top side.

FIG. 4C shows one embodiment the tactile buckling layer from the side.

FIG. 5A shows one embodiment the tactile buckling layer triggering mechanism from the top.

FIG. 5B shows one embodiment the tactile buckling layer triggering mechanism from the side.

FIG. 5C shows one embodiment the tactile buckling layer triggering mechanism from bottom.

FIG. 5D shows one embodiment the tactile buckling layer buckling under the minimal threshold.

FIG. 6 shows one embodiment of the flexible switch sensor inside an enclosure

FIG. 7 shows the results and feedback of sensor assemblies when compressional force is applied to the system.

FIG. 8 shows that there is no result or feedback when the sensor assemblies have twist or bend deformational forces applied to the system.

FIG. 9 shows the positioning of the sensor assemblies in one embodiment of a 2D system.

FIG. 10 shows an embodiment of the sensor assemblies incorporated onto a 3d system. In this embodiment, the sensor assemblies on the human hands.

FIG. 11 shows the positioning of the sensor assemblies in another embodiment of a 2D system.

FIG. 12A shows one embodiment of the tactile sensor as a spring mechanism.

FIG. 12B shows the spring tactile sensor compressing under the minimal threshold.

### DETAILED DESCRIPTION

The above mentioned aspects, as well as other aspects, features, and advantages of the present technology will now be described in connection with various embodiments. The inclusion of the following embodiments is not intended to limit the invention to these embodiments, but rather to enable any person skilled in the art to make and use this invention. Other embodiments may be utilized and modifications may be made without departing from the spirit or scope of the subject matter presented herein. Aspects of the disclosure, as described and illustrated herein, can be arranged, combined, modified, and designed in a variety of different formulations, all of which are explicitly contemplated and form part of this disclosure.

Disclosed herein are systems including pressure sensor assemblies that respond to isolated compressive deformational forces and methods for using such systems. In general, the systems and methods described herein are used by a user. A user may include: an entertainer for a live audience (e.g., stage performances, outdoor performances, subway stations, cities, parks, restaurants etc.); a disc jockey (DJ); a technician (e.g., audio, electronic, sound, telecommunications, etc.); a video game player; a VR user; a scientist; a performer or musician (e.g., pianist, soloist, conductor, etc.); or any other person needing or using the systems and methods described herein.

One aspect of the present disclosure is directed at how to decouple electrodes to only trigger when desired forces are applied. In some embodiments, the electrodes may be on different layers, only coming in contact when the two layers touch directly or through an intermediary semiconductive layer. In some embodiments, the electrodes may be on the same layer, where each electrode can be on any number of rigid, rigid-flex, flexible, textile, or other soft good materials. In some embodiments, the electrodes may be on the same layer. When on the same layer, the electrodes should never touch, and there threshold for how close they are is dependent on the material choice. In some embodiments, the electrodes may be on different layers, placed on top of each other, and include an intermediary conductive layer.

Another aspect is material choice for the electrodes and their traces. Given the potentially flexible environment, like a wearable electronic, electrodes may be made out of a number of different conductive materials, including graphene, conductive thread, conductive ink, or other forms of carbon impregnated polycarbonate layers. In one embodiment, the conductive traces and notes comprise or are formed of graphene. Graphene creates a consistent connection that would remain durable even due to twist, bend, and other forms of forces. In rigid scenarios, the conductive traces are traced on a rigid printed circuit board (PCB), flexible PCB, or elastomeric PCB.

Another aspect of the present disclosure is the spacer design. In certain embodiments, the spacer is cut out in any number of patterns, with the pattern size and variability being dependent on how much and which direction a sensor would move. For example, a spacer designed to ignore bending wrist environment would make the width of a pattern feature smaller than the potential diameter created by a bend. The insulating spacer is designed depending on which forces (e.g., bend, twist, etc.) to ignore when triggering the switch sensor. In certain embodiments, the non conductive laminate layers are cut in a hexagonal pattern, which allows for the greatest amount of elastic deformation without causing delamination of the thin layers. Alternatively, the non-conductive laminate layers may be cut in any pattern (e.g., square, circular, oval, trapezoidal, rectangular, etc.) that allows for the greatest amount of elastic deformation without causing delamination of the thin layers. By retaining a spacer ratio that allows the maximum force over cross sectional area, the embodiments described herein prevent failure of layers and false positive sensor inputs. Once pressure is applied to the sensors, conductive piezoresistive layers can communicate with one another. While spacers and switch sensors tend to be designed to expect a flat surface, being able to create perforations based on expected deformations allow for a switch sensor to work in many more flexible environments rather than just rigid environments.

Another aspect of this present disclosure discusses the piezoresistive layer itself. The piezoresistive layer comprises or is formed of a carbon impregnated polymer, a graphene-based polymer, or any other sort of piezoresistive element. The piezoresistive layer has the rigidity to only go through the holes in the insulating spacer when the intended force is applied. In another embodiment, one or more piezoresistive layer are configured to match one or more locations of one or more holes in the insulating spacer. This matching prevents other forces in the sensor, for example from the manufacturing process itself, from impacting the resistivity of the piezoresistive element.

Another aspect of the present disclosure describes the non-conductive enclosure. The enclosure comprises or is formed of a number of materials depending on needs like waterproofing. For example, this enclosure could be made from silicone treated with waterproofing. In some embodiments, it could also be some sort of Vistal elastic layer, flexible laminate, or any number of rigid polymers or metals.

Another aspect of the present disclosure describes elastic tactile elements. The elastic tactile element comprises or is formed of an elastomeric polymer or a mechanical means. The elastic tactile element provides a physical separation between unintended external forces and an intended full use of the pressure sensor. The elastic tactile element is configured to display a physical reaction to being pressed such that it is easy to perceive and quick to reset. For example, in some embodiments, the elastic tactile element comprises or is formed of a high-walled elastomeric polymer that buckles when pressed or when pressure is applied. The buckling or spring effect gives feedback to the user (e.g., the press has begun). Such tactile feedback serves two purposes. (1) It allows for the sensor to have a higher sensitivity without or with reduced false positives, and (2) it gives the user physical feedback when the sensor has triggered.

In some embodiments, the piezoresistive material is suspended within the tactile element, thus creating more space between the piezoresistive material and the plurality of electrodes. The buckling or spring effect creates a compression in the tactile element that causes the suspended piezoresistive material to make contact with the electrodes.

Another aspect of the present disclosure describes maximizing sensor location, based on maximizing finger trigger speed. In some embodiments, the sensors may be placed directly on the hand, with a glove or glove-like enclosure, including index, middle, ring, pinky, and thumb fingertips, palm area near or proximate to an ulna bone, palm area near or proximate to a radius bone, on a side of a metacarpus bone, on top of a metacarpus bone, and/or on a side, top, and/or bottom of a phalanx. In some embodiments, the sensor system could also be extended across the body, including elbow, side, top or bottom of forearm, any to multiple locations on the chest, multiple locations on thighs, glutes, shins, etc.

In some embodiments, the width of the sensors of the embodiments are designed to allow for the maximum variations of user interaction while conserving the most space or area possible. The optimal sensor width required to achieve the most ergonomic design was also determined by many iterations of testing. The surface area of each sensor was designed by testing most tapped areas by human hands. Spacer cut designs were developed by testing conductive contact on varying levels of deformation and therefore differing cut patterns allow control over levels of responsiveness.

In some embodiments, the sensor assembly comprises a top substrate, a bottom substrate, a piezoresistive element, a tactile layer, an insulating spacer, and an electrode in a specialized position and comprising a conductive material. The sensor assembly elements have more than 3,000 permutations based on material decisions by the user, which allow varying levels of utility. These permutations will all result in an end product that allows compressive deformational forces to complete conductive connections while isolating bending or twisting deformational forces from triggering electrical conductivity.

In some embodiments, the insulating spacer comprises or is formed of one or more laminate structures that serve to stabilize positioning of one or more piezoresistive elements. The insulating spacer comprises varying degrees of flexibility; however, in some embodiments, there is a pattern designed by the user incised into the insulating layer to allow the piezoresistive elements to interact with positive and negative electrodes.

As used herein, a “tactile layer” refers to substrate when under deformation will buckle and shift in structure, but return to its original state after the deformational pressure is released from the substrate. For example, tactile layers may comprise or be formed of elastomeric elements such as varying types of silicone, amorphous polymers, semicrystalline polymers, biopolymers, and high temperature metals. The aim of these elements are to provide haptic feedback to the user when they press onto a switch or pressure sensor assembly system allowing them to know that a toggle action from off to on or some other change occurred as a result of their physical interaction. In some embodiments, these tactile layers can also act as a spring.

As used herein, a “pressure sensor assembly” refers to any combination of layers resulting in a switch system that allows transference of conductivity, typically through a piezoresistive unit. The purpose of these switch systems are to toggle events on and off as desired by the user of the components. For example, pressure sensor embodiments may be located in electronic musical instruments, remote control systems, analog controller technologies, wearable fabrics, etc.

As used herein, a “piezoresistive element” is indicative of a substance that allows a change in electrical resistivity when mechanical strain is applied to the assemblies containing the piezoresistive elements. In many embodiments, the piezoresistive elements allow conductivity between electrodes to transfer through the electrodes that surround the piezoresistive element resulting in a completed electrical circuit in specific deformational instances. In some embodiments, the piezoresistive elements allow for compressional forces to create a completed conductive circuit while bending or twisting deformational forces would not be allowed to create completed conductive circuits. Non-limiting examples of piezoresistive elements includes carbon impregnated material including laminate, elastomeric polymer, textiles, and polyfins.

As used herein, “deformational forces” describe pressure that is a result of either tensile or compressive forces from an external source or multiple sources in some embodiments affecting a separated unit. Deformational forces cause the structures in some embodiments to buckle and cause a shift in its form. For a newtonian force to be considered deformative, that force must cause a fluctuation in the subsurface of the affected unit. The deformation of substrates by the result of external forces, allow systems in some embodiments to act as a switch transferring electrical signals from one conductive layer to another. Non-limiting examples of deformational forces include both compressions by physical objects, torque applied by twists or bends, and tensile forces via pulls or stretches.

As used herein, an “insulating spacer” defines an element that does not allow electrical charges to flow freely within the medium. In some embodiments, the insulating spacer is comprises or is formed of flexible materials that can withstand varying levels of deformational forces and return to their original structure. In some embodiments, these insulating spacers are perforated allowing adjacent layers on either side of the insulating spacers to interact with each other and pass electrical signals through the areas created by the perforations. Non-limiting examples of materials that could be used as insulating spacers include plastics, laminates, rubber, or wood.

As used herein, a “substrate” refers to any material that acts as a surface on which something is deposited or inscribed. In some embodiments, substrates act as surfaces for conductive and non conductive elements which interact with electrons and forces acting within and through the assembly. Non-limiting examples of substrates include carbon fiber, leather, synthetic leather, wood, metal, rubber, silicone, plastic, or any other material known by those who are well versed in the related fields. In some embodiments, certain substrates are typically less than 3 mm in thickness.

As used herein, a “sensor orientation” refers to the placement of individual sensor assemblies in various embodiments in order to maximize the ergonomic use of electronic devices and textiles that would incorporate the sensor assemblies into their functionality. The orientations of these sensors are located in areas where the most compressive forces would be applied in various embodiments. Examples of these orientational areas would be various two dimensional surfaces such as rigid electronic devices or three dimensional flexible surfaces including wearable textiles or fabrics.

As used herein, “thou” refers to 1/1,000 of an inch.

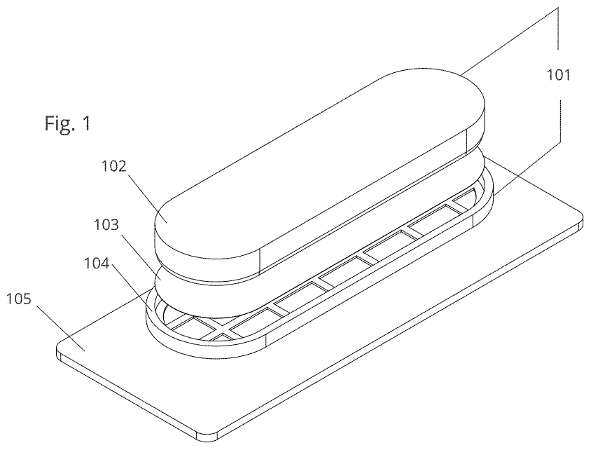

FIG. 1 illustrates the compositional layering system of the sensor assembly 101. The uppermost component is the tactile layer 102 that supplies haptic feedback to the user upon receiving compressive input. Another component is the piezoresistive material 103, which in some embodiments is placed into a perforated housing 104 for the piezoresistive material 103 to interact with conductive elements. The sensor assembly is placed onto substrate 105.

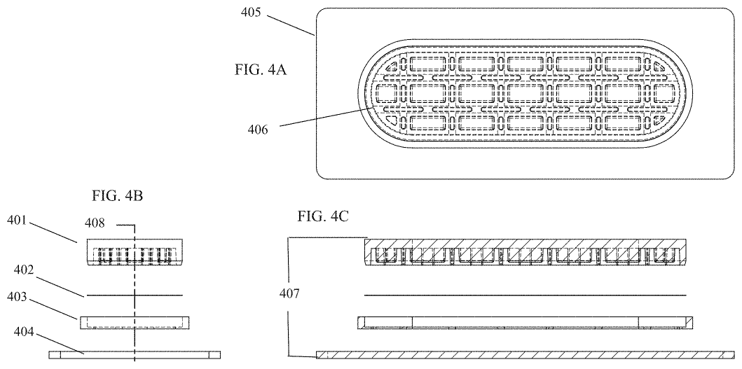

FIGS. 4A-4C depict an embodiment illustrating the full utility and functionality of a tactile layer with buckling elements and haptic feedback. The buckling resistance is less than 1N, allowing for individual fingers to effect buckling. FIG. 4A depicts the tactile layer 406 superimposed upon a substrate 405. FIG. 4B defines the compositional elements with respect to proposed thicknesses of layers, in various embodiments. In some embodiments, the tactile layer 401 which lies above the piezoresistive layer 402, that is placed within non-conductive layer 403, and all of the above layers are superimposed upon substrate layer 404. This sensor assembly 407 is acted upon by compressive forces from area 408.

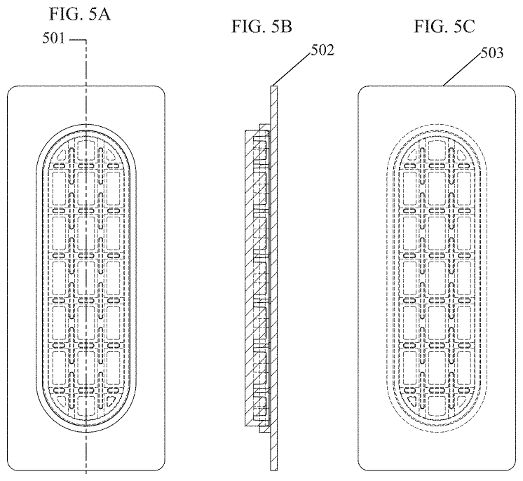

FIGS. 5A-5C illustrate an embodiment where the tactile layer is superimposed upon a substrate 503 and the sensor assembly is enclosed. Substrate 502 has a variable thickness ranging from 3 thou to 12 thou. The tactile layer and superimposed substrates are acted upon by compressive deformational forces originating from area 501. FIG. 5D illustrates the elastomer walls 505 buckling under the compression force 504 with a minimal threshold of IN.

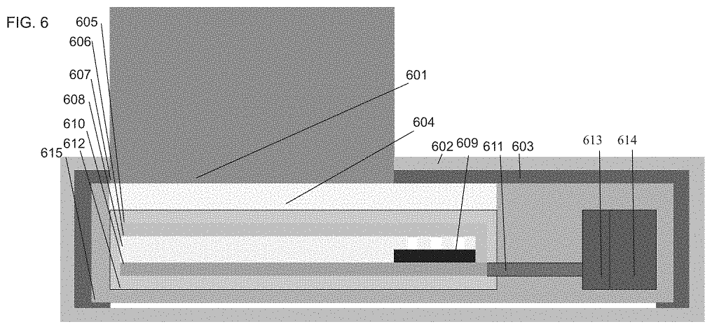

Referring to FIG. 6, a sensor assembly is shown which is formed of a top sensor assembly 605 and a bottom sensor assembly 612. This sensor assembly is surrounded by encasement 602 and 603, wherein 602 serves to protect the system from environmental impacts and 603 supplies protective structure. Internally, layer 615 supports electrical components and the sensor assembly. In some embodiments, electronic components would be the board 613 (typically, a microcontroller) to interface with external technological systems (e.g. computers, tablets, mobile devices, medical equipment, musical devices, etc) and the battery 614 to power the board. Top sensor assembly 605 and bottom sensor assembly 612 include electrodes 607 and 610, with one plurality of electrodes placed in a perpendicular pattern relative to a second plurality of electrodes. Layer 609 comprises a piezoresistive element, for example a carbon impregnated laminate or poleflyin. For placement, laminate 608 functions to position a piezoresistive element and maintain it in place. Further, laminate 608 provides insulation between the two electrodes. In some embodiments, the laminate 608 may have one or more holes or perforations. The radius of any window in the laminate is smaller than capable travel of the material in 609 when applied with bend or twist deformations. In other embodiments, laminate 608 may comprise or be formed of a shaped pattern, including hexagon shape, pentagon shape, circular shape, and/or rectangular shapes of varying side numbers. The size and/or shape of these patterns is dependent on a desired bend and twist resistance for the pressure sensor. The electrodes 607 and 610 are coupled to an output terminal 611. The outer layer substrates 605 of bottom sensor assembly 612 comprise or are formed of laminin that provides more rigidity than any of the internal components. In some embodiments, a thicker laminate may comprise a thickness of 3 thou, 4 thou, or 5 thou of a non conductive laminate polymer. It could then be connected to a larger electronic system as an individual sensor.

In some embodiments of FIG. 6, a sensor assembly may include a tactile layer 601, for example, positioned on a top of the sensor assembly. The tactile layer 601 may be formed of or comprise one or two elastomeric elements. In certain embodiments, a bottom elastomeric element 604 may comprise or be formed of a softer durometer elastomeric polymer, with a durometer between 10 A and 40 A, with the top elastomeric tactile layer being a harder durometer rating over 60 A. In other embodiments, there may be a single elastomeric tactile layer, a solid structure and a durometer rating of over 60 A. In some embodiments, the thickness of the elastomeric layer may be 1 cm, 2 cm, or 3 cm thick, 0.5 to 1 cm, 1 to 3 cm, 2.5 to 3.5 cm. In other embodiments, tactile layer 601 may comprise or be formed of a softer durometer of between 20 A to 40 A Shore durometer, and provide a buckling structure, as shown and described in FIG. 5A.

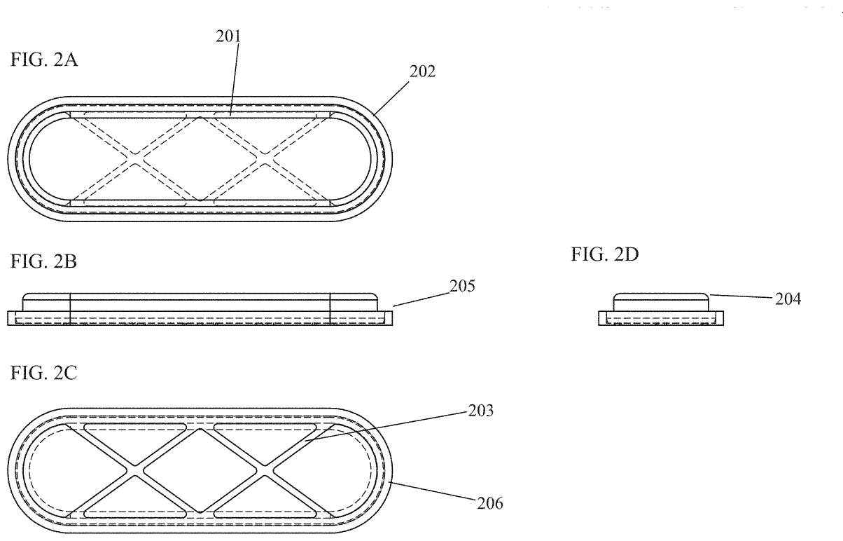

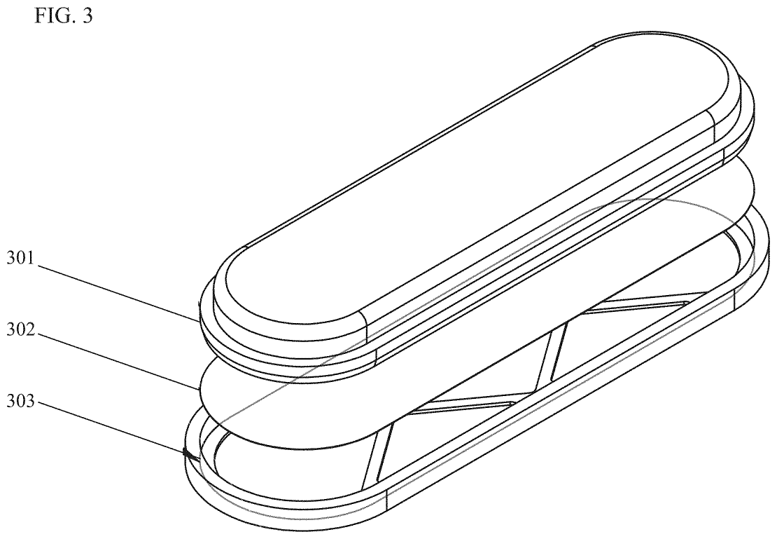

Turning to FIGS. 2A-2D and FIG. 3 which illustrate another embodiment of the invention which differs from that shown in FIG. 6 in that both electrodes 606 and 612 are on the same substrate 206, and the connecting traces are formed on the substrate. Since all of the leads are on the same substrate, the electrodes are placed in a parallel pattern, preventing contact in the absence of a third electrode substrate. The third electrode 302 is separated from electrodes 606, 612 with an insulating spacer layer 303. The insulating spacer layer 303 comprises or is formed of an enclosure border 202 for the piezoresistive element 302. The windows in 203 permit electrical contact between terminals 302 and traces found on substrate 105. The apertures separating the electrodes 606, 612 from the piezoresistive in layer 203 can be any number of different patterns, including small perforations between 1-3 thou in diameter, with the thickness of the spacer between 3 to 4 thou, 4 to 5 thou, or 5 to 6 thou. If the thickness is greater, the diameter of the perforations would be equivalent. Thus, a 3 thou thickness would mean the perforation diameter is 3 thou. The minimal bend radius for any location is 0.1 mm. For example, the bend radius may be 0.05 to 0.1 mm; 0.05 to 1 mm, 0.01 to 1 mm, 0.1 to 2 mm, etc. In certain embodiments, layer 201 may also be some shaped mesh pattern, including square, circular, pentagon, hexagon, or any other shaped polygon. The material of piezoresistive element 302 must be able to travel through the windows in layer 203 when compression deformation pressure is applied. Tactile pad 301 can be positioned inside of layer 302, enclosing the piezoresistive element 302. Another embodiment of the invention is designated by the tactile layer 204 which is superimposed above the sensor assembly 205. In some embodiments, the insulating spacer layer 303 may only provide the outer border 202, and not layer 203, with the functionality of layer 203 being separated by a perforated laminate layer placed between layer 301 and elastomeric layer 303. Buckling element 301 comprises or is formed of either a mechanical or elastomeric element, such that when it is compressed with compression deformation, buckling element 301 contacts element 302 and push it through the layer 203 defined by the insulating layer 303, thus making contact with the electrode layers, and triggering a piezoresistive signal (e.g., analog signal).

In some embodiments, as shown in FIG. 3, a thickness of insulating spacer layer 303 does not exceed 1 thou, 2 thou, 3 thou, 4 thou, 5 thou, 6 thou, 7 thou, 8 thou, 9 thou, 10 thou, 11 thou, or 12 thou. Further, in some embodiments, as shown in FIG. 3, a thickness of element 302 does not exceed 1 thou, 2 thou, 3 thou, 4 thou, 5 thou, 6 thou, 7 thou, 8 thou, 9 thou, 10 thou, 11 thou, or 12 thou. In some embodiments, the thickness of layer 302 is equal to the thickness of layer 201 and layer 203.

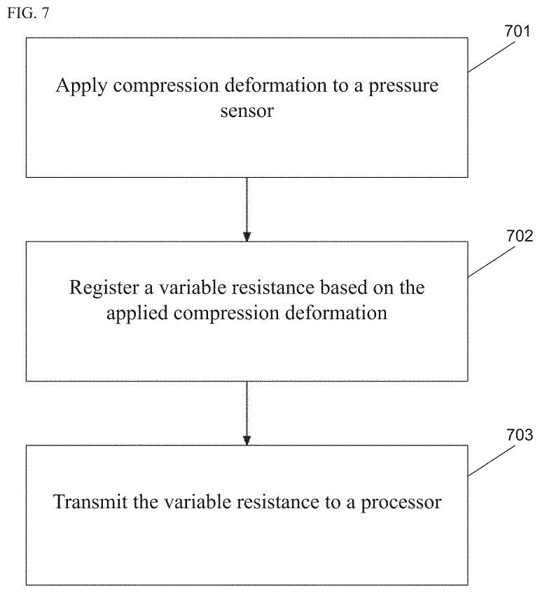

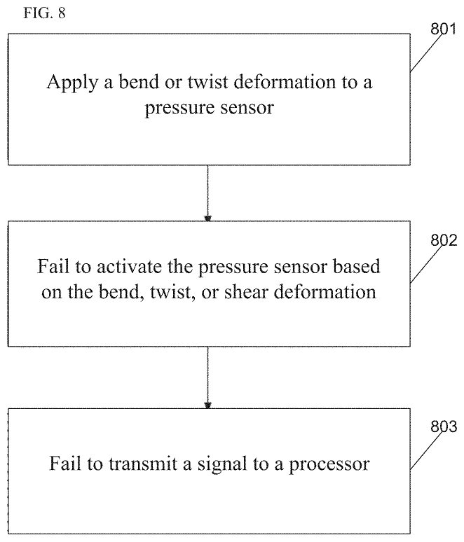

FIGS. 7 and 8 illustrate a method of activating the pressure sensor assembly in which the pressure sensor assembly is activated only when compression deformation is applied to the pressure sensor assembly. As shown in block 801, a bend or twist deformation is applied to the pressure sensor assembly. Given the nature of the insulating spacer layer and it's perforated design, as described elsewhere herein, the piezoresistive element 103, 302, 402, or 609 does not travel through the insulating spacer layer when these bending or twisting forces are applied. Therefore, as shown, in block 802, the electrodes do not connect, and therefore no circuit is completed. As such, no signal is sent to the processor as indicated by feedback 803. In the case of FIGS. 7-8, compression pressure is applied at block 701. The compression pressure allows the piezoresistive element to travel or deform through the insulating spacer layer, for example an aperture in the insulating spacer layer as described elsewhere herein. This allows the piezoresistive element to make contact with the electrodes completing the circuit. The amount of pressure applied changes the variable resistance of this circuit in block 702. Thus, at block 703, the resistance analog signal is sent to the processor.

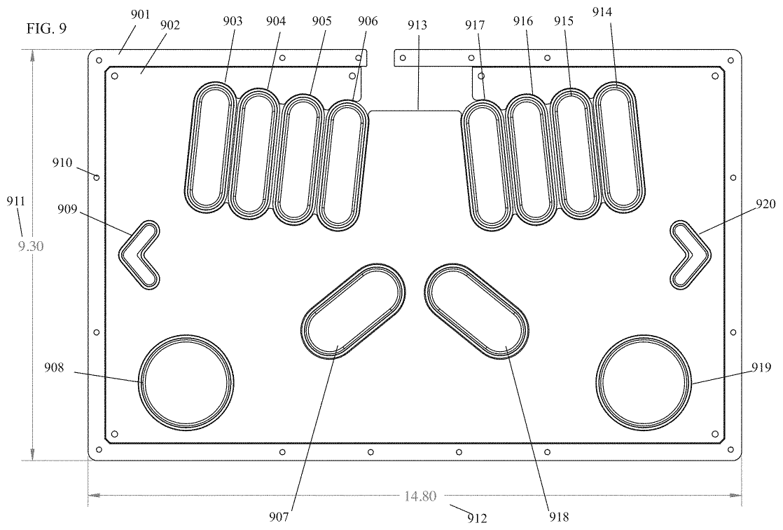

FIG. 9. provides one embodiment of a potential positioning of the pressure sensors. In this embodiment, the sensors are projected on a flat surface. The positioning of the sensors are designed to maximize the ability for individual fingers to simultaneously press multiple sensors. In some embodiments, the width of this surface 912 is 9 inches, 10 inches, 11 inches, 12 inches, 13 inches, 14 inches, 14.5 inches, 15 inches, 16 inches, 9 to 16 inches, 10 to 20 inches, 9 to 12 inches, at least 9 inches, 11 to 16 inches, etc. The positioning of the sensors, starting from the center, relative to the width and height of the entire surface, in X, Y axis notation, are: Left index −0.117, 0.238 (906), Left middle −0.117, 0.255 (905), Left ring −0.26, 0.269 (904), Left pinky −0.33, 0.286 (903), Left thumb −0.1, −0.15 (907), Left palm −0.37, −0.34 (908), Right index 0.117, 0.238 (917), Right middle 0.117, 0.255 (916), Right ring 0.26, 0.269 (915), Right pinky 0.33, 0.286 (914), Right thumb 0.1, −0.15 (918), Right palm 0.37, −0.34 (919). The rotation of the sensors, starting from the center, are: Left index −6° (906), Left middle −6° (905), Left ring −6° (904), Left pinky −6° (903), Left thumb −6° (907), Left palm −6° (908), Right index 6° (917), Right middle 6° (916), Right ring 6° (915), Right pinky 6° (914), Right thumb 6° (918), Right palm 6° (919). These positions may have relative thresholds of +/−0.2 in relative distance, and +/−10° in relative rotation.

FIG. 9 displays various sensor assemblies in positions that allow maximum concussive input and each of these assemblies are relegated to a particular digit or function. Assemblies 903, 904, 905, 906, and 907 are assigned to the pinky, ring, middle, pointer, and thumb fingers of the left hand, respectively, while assemblies 914, 915, 916, 917, and 918 are designated to the pinky, ring, middle, pointer, and thumb digits of the right hand. In order to maximize utility, this embodiment also employs assemblies 908 and 919 as the sensor assemblies for the palm for the left and right hand respectively. In this embodiment, it is essential for these sensor assemblies to possess a high level of durability as these pieces must withstand the strongest concussive impacts. Assemblies 909 and 920 are designated for use with the metatarsal bones on the side of the human hand. Assembly 901 illustrates an encasement that could be used in this embodiment, while assembly 902 defines the substrate layer holding sensor assemblies that also acts as an impact cushion for residual concussive forces. Conductive element 913 t links each sensor assembly and allows them to send signals to electronic components. In this embodiment, areas 911 and 912 are the optimal height and width in inches of the positioning system displayed. The through-holes 910 indicates various pieces in this embodiment that are utilized to attach layers of the system.

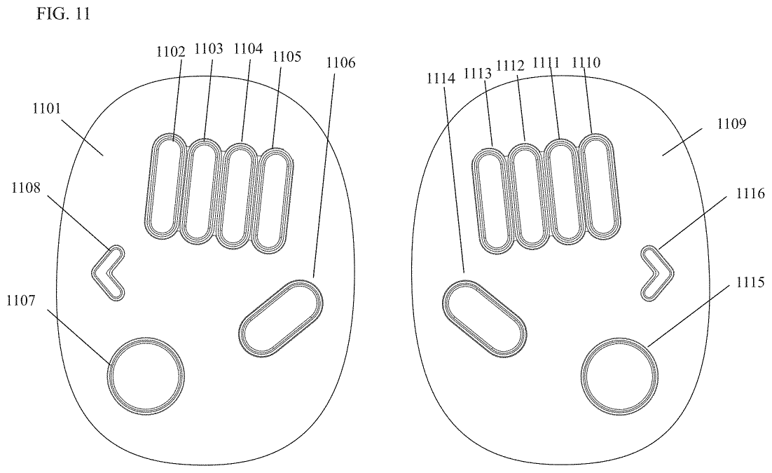

FIG. 11 shows another embodiment of a flat surface system, similar to that shown and described in FIG. 9. As shown in FIG. 11, each hand is separated as a separate controller 1101 and controller 1109. This allows each pad to be placed in different locations or positions. For example, each pad can be strapped to a leg, allowing users to use the system without the need for a flat surface, given the capabilities of the sensors working in flexible, wearable environments. In this scenario, the positions would be be similar to that shown in the FIG. 9. The positioning of the sensors, relative to the center of both pads are placed next to each other, in X, Y axis notation, are: Left index −0.117, 0.238 (1105), Left middle −0.117, 0.255 (1104), Left ring −0.26, 0.269 (1103), Left pinky −0.33, 0.286 (1102), Left thumb −0.1, −0.15 (1106), Left palm −0.37, −0.34 (1107), Right index 0.117, 0.238 (1113), Right middle 0.117, 0.255 (1112), Right ring 0.26, 0.269 (1111), Right pinky 0.33, 0.286 (1110), Right thumb 0.1, −0.15 (1114), Right palm 0.37, −0.34 (1115). The rotation of the sensors, starting from the center, are: Left index −6° (1105), Left middle −6° (1104), Left ring −6° (1103), Left pinky −6° (1102), Left thumb −6° (1106), Left palm −6° (1107), Right index 6° (1113), Right middle 6° (1112), Right ring 6° (1111), Right pinky 6° (1110), Right thumb 6° (1114), Right palm 6° (1115). These positions may have relative thresholds of +/−0.2 in relative distance, and +/−10° in relative rotation. Sensor 116 and sensor 115 provide optional software configuration triggers.

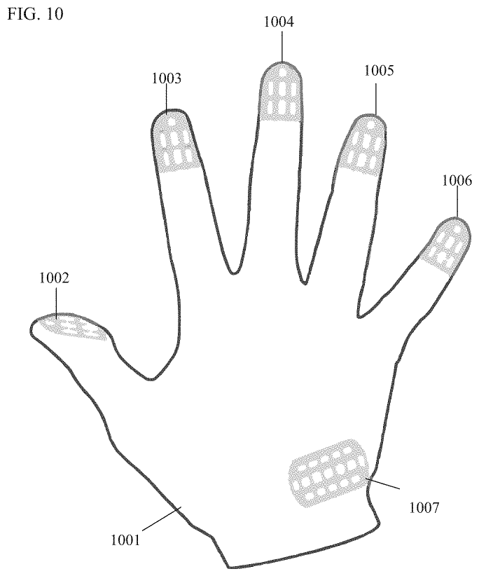

FIG. 10 displays an embodiment of these sensor assemblies as applied on a wearable textile 1001. This embodiment illustrates a human hand capable of applying both bending or twisting forces and compressive forces onto sensor assemblies displayed in assemblies 1002, 1003, 1004, 1005, and 1006 which are relegated to thumb, pointer, middle, ring, and pinky fingers, respectively. Palm assembly 1007 reflects the region of the palm, which not only requires a much larger surface for the palm assembly, but the palm assembly also sustains the largest deformational and compressive forces and should maintain high levels of durability.

FIG. 10 shows a wearable embodiment (e.g., glove) of the sensor layout, allowing each flexible sensor to be placed in ideal locations for pressure sensor triggering. These positions include, for example, the distal phalange of a thumb, the distal phalange of an index finger, the distal phalange of a middle finger, the distal phalange of a ring finger, the distal phalange of a pinky finger, a palm area near or proximate of the ulna bone, a palm area near or proximate a radius bone, on a side of a metacarpus bone, on top of a metacarpus bone, on a side, top, or bottom of a phalanx, etc. Such sensor system positioning could also be extended across the body, including elbow, side, top or bottom of forearm, to multiple locations on the chest, multiple locations on thighs, glutes, shins, etc.

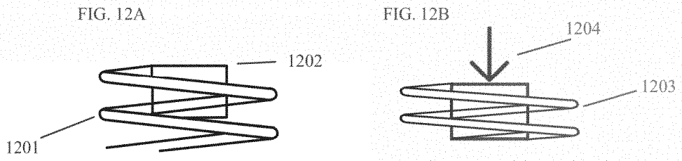

FIGS. 12A-12B show another embodiment of the tactile sensor pad, with a spring shaped elastomer 1201 suspending the piezoresistive element in assembly 1202, with the piezoresistive element exposed from the bottom of assembly 1202. When compression force 1204 is applied with a force greater than 1N, the spring 1203 compresses, allowing assembly 1202 to make contact with the electrodes, allowing the piezoresistive element to make contact with the electrodes. The spring elastomer 1201 can be a height between 0.1 cm to 5 cm.

As used in the description and claims, the singular form “a”, “an” and “the” include both singular and plural references unless the context clearly dictates otherwise. For example, the term “spacer” may include, and is contemplated to include, a plurality of spacer. At times, the claims and disclosure may include terms such as “a plurality,” “one or more,” or “at least one;” however, the absence of such terms is not intended to mean, and should not be interpreted to mean, that a plurality is not conceived.

The term “about” or “approximately,” when used before a numerical designation or range (e.g., to define a length or pressure), indicates approximations which may vary by (+) or (−) 5%, 1% or 0.1%. All numerical ranges provided herein are inclusive of the stated start and end numbers. The term “substantially” indicates mostly (i.e., greater than 50%) or essentially all of a device, substance, or composition.

As used herein, the term “comprising” or “comprises” is intended to mean that the systems and methods include the recited elements, and may additionally include any other elements. “Consisting essentially of” shall mean that the systems and methods include the recited elements and exclude other elements of essential significance to the combination for the stated purpose. Thus, a system or method consisting essentially of the elements as defined herein would not exclude other materials, features, or steps that do not materially affect the basic and novel characteristic(s) of the claimed invention. “Consisting of” shall mean that the systems and methods include the recited elements and exclude anything more than a trivial or inconsequential element or step. Embodiments defined by each of these transitional terms are within the scope of this disclosure.

The examples and illustrations included herein show, by way of illustration and not of limitation, specific embodiments in which the subject matter may be practiced. Other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A flexible piezoresistive switch sensor, comprising;
a non-conductive substrate;
a first plurality of electrodes formed on the non-conductive substrate;
a second plurality of electrodes formed on the non-conductive or a second non-conductive substrate, with the second plurality of electrodes not in contact with the first plurality of electrodes;
an insulating spacer layer, wherein the non-conductive substrate is configured to prevent contact between the first plurality of electrodes and the second plurality of electrodes unless pressure is applied;
a piezoresistive substrate separated from the first and second plurality of electrodes by the insulating spacer layer; and
one or more interconnected apertures defined by the insulating spacer layer which is configured to prevent contact between the plurality of electrodes and the piezoresistive substrate during one or more of bend deformations and twist deformations, while allowing contact between the first plurality of electrodes and the second plurality of electrodes during compression deformation.

2. The sensor of claim 1, wherein the first plurality of electrodes and the second plurality of electrodes are both on the non-conductive substrate.

3. The sensor of claim 1, wherein the first plurality of electrodes is formed on the non-conductive substrate and the second plurality of electrodes is formed on a second non-conductive substrate.

4. The sensor of claim 2, wherein the first plurality of electrodes is substantially parallel in a first direction, and the second plurality of electrodes is substantially perpendicular to the first plurality of electrodes.

5. The sensor of claim 3, wherein the first plurality of electrodes is substantially parallel to the second plurality electrodes, such the first plurality is not in contact with the second plurality.

6. The sensor of claim 1, wherein each of the pluralities of interconnected apertures is comprised of circle, circle-like, or polygonal shapes with 3, 4, 5, 6, 7, 8, or 9 sides.

7. The sensor of claim 6, wherein the width of each aperture is equal to or less than the maximum desired bend radius at the location of the sensor.

8. The sensor of claim 7, wherein a width of each aperture is at least 0.1 mm.

9. The sensor of claim 1, wherein the insulating spacer layer comprises of an elastomer.

10. The sensor of claim 1, wherein one or more of the first plurality of electrodes and the second plurality of electrodes are printed on an elastomer.

11. The sensor of claim 1, wherein one or more of the first plurality of electrodes, or the second plurality of electrodes, or the piezoresistive element is printed on a soft goods textile material selected from the group consisting of: animal material, plant material, mineral material, and synthetic material.

12. An elastomeric tactile sensor pad, comprising;
a non-conductive substrate;
a first plurality of electrodes formed on the non-conductive substrate;
a second plurality of electrodes formed on the non-conductive substrate or a second non-conductive substrate, with the second plurality of electrodes is not in contact with the first plurality of electrodes;
an insulating spacer layer, wherein the non-conductive substrate is configured to prevent contact between the first plurality of electrodes and the second plurality of electrodes unless pressure is applied;
a piezoresistive substrate separated from the first and the second plurality of electrodes by the insulating spacer layer;
one or more interconnected apertures defined by the insulating spacer layer which is configured to prevent contact between the plurality of electrodes and the piezoresistive substrate during one or more of bend deformations and twist deformations, while allowing contact between the first plurality of electrodes and the second plurality of electrodes during compression deformation;
a plurality of interconnected buckling columns or springs comprising an elastomeric material; and
a buckling point or spring resistance requiring less than 1 N of compression pressure.

13. The pad of claim 12, wherein the plurality of interconnected buckling columns or springs comprises or is formed of geometric shapes comprising 3, 4, 5, 6, 7, 8, or 9 sided shapes.

14. The pad of claim 12, wherein the plurality of interconnected buckling columns or springs comprises elastomeric hairs.

15. The pad of claim 12, wherein a bottom surface of the sensor pad defines a second set of interconnected apertures configured to allow compression force applied to the sensor pad to travel through the second set of interconnected apertures.

16. The pad of claim 12, wherein the mean height is 0.1 cm to 3.5 cm.

17. The pad of claim 12, wherein the piezoresistive element is suspended in the pad, between the interconnected buckling columns or in the center of the spring.

18. The pad of claim 17, wherein the suspended enclosure housing the piezoresistive element has a height greater than the height of the interconnected columns or compressed spring.

19. The pad of claim 18, wherein the mean height of the interconnected columns or compressed spring is 0.1 cm to 5 cm.
